(19) United States
(12) Patent Application Publication
(10) Pub. No.: US 2024/0103967 A1
(43) Pub. Date: Mar. 28, 2024

(54) Memory Decoder Providing Optimized Error Detection and Correction for Data Distributed Across Memory Channels

(71) Applicant: International Business Machines Corporation, Armonk, NY (US)

(72) Inventors: Barry M. Trager, Yorktown Heights, NY (US); Patrick James Meaney, Poughkeepsie, NY (US); Glenn David Gilda, Binghamton, NY (US); Lawrence Jones, Endwell, NY (US)

(21) Appl. No.: 17/954,464

(22) Filed: Sep. 28, 2022

(51) Int. Cl. G06F 11/10; G06F 11/22

(52) U.S. Cl. CPC G06F 11/1068; G06F 11/1004; G06F 11/2273

(57) ABSTRACT

A memory controller stores each of a plurality of data blocks encoded by error correction code (ECC) across multiple channels of a redundant memory system. Based on receiving, from the memory system, channel data of a fetch operation requesting a data block, the memory controller decodes the channel data and concurrently generates a predicted channel mark based on tests of channel-induced syndromes generated from the channel data. The predicted channel mark identifies a marked channel among the multiple channels as a likely source of data errors. The memory controller determines whether the decoding detects an uncorrectable error in the channel data and, based on determining the decoding detects an uncorrectable error in the channel data, re-reads channel data corresponding to the data block and corrects the re-read channel data by excluding, from decoding, channel data received from the marked channel.

### BACKGROUND OF THE INVENTION

The present invention relates in general to data processing, and in particular, to memory systems for data processing systems. More particularly, the present invention relates to improved error detection and correction in a redundant memory system of a data processing system.

Redundant array of independent memory (RAIM) systems have been developed to improve performance and to increase the availability and reliability of memory systems. Similar to redundant array of independent disk (RAID) systems commonly utilized for non-volatile storage, RAIM systems distribute blocks of data across several independent memory channels. The data blocks distributed across the memory channels are typically protected by one or more coding schemes, such as parity, cyclic redundancy code (CRC), and error correction code (ECC). Many different RAIM schemes that have been developed, each having different characteristics and different associated advantages and disadvantages.

### SUMMARY OF THE INVENTION

In at least one embodiment, a memory controller stores each of a plurality of data blocks encoded by error correction code (ECC) across multiple channels of a redundant memory system, such a redundant array of independent memory (RAIM) system. Based on receiving, from the memory system, channel data of a fetch operation requesting a data block, the memory controller decodes the channel data and concurrently generates a predicted channel mark based on tests of channel-induced syndromes generated from the channel data. The predicted channel mark identifies a marked channel among the multiple channels as a likely source of data errors. The memory controller determines whether the decoding detects an uncorrectable error in the channel data and, based on determining the decoding detects an uncorrectable error in the channel data obtains channel data corresponding to the data block and corrects the channel data by excluding, from decoding, channel data received from the marked channel. In some embodiments, the channel data may be re-fetched from the memory system. In other embodiments, the memory controller may contain data buffers for buffering data received from the memory system, and the channel data can be re-read from these data buffers rather than from the memory system.

By decoding the data block in parallel with the generation of the predicted channel mark, the critical path through the RAIM decoder is reduced, improving fetch latency for the most common case in which no channel mark is predicted.

### BRIEF DESCRIPTION OF THE DRAWINGS

FIG. 1 is a high-level block diagram of an exemplary data processing system in accordance with one embodiment;

FIG. 2 is a more detailed block diagram of a redundant array of independent memory (RAIM) fetch circuit within the memory controller of FIG. 1 in accordance with one embodiment;

FIG. 3 is a more detailed block diagram of the redundant array of independent memory (RAIM) decoder of FIG. 2 in accordance with one embodiment; and

FIG. 4 is a high-level logical flowchart of an exemplary method of RAIM decoding in accordance with one embodiment.

### DETAILED DESCRIPTION OF ILLUSTRATIVE EMBODIMENT

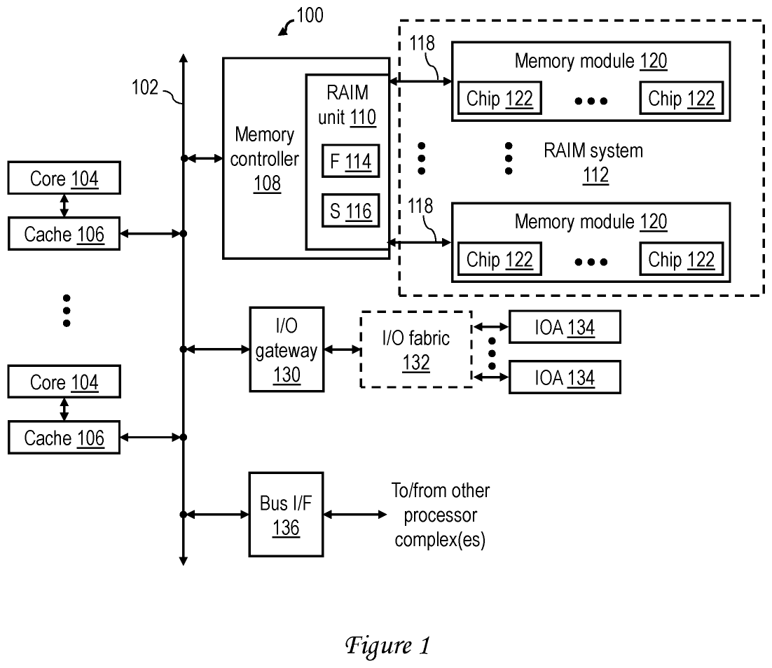

With reference now to the figures, and in particular with reference to FIG. 1, there is illustrated a high-level block diagram of an exemplary data processing system 100 in accordance with at least one embodiment. In some implementations, data processing system 100 can be implemented as a single integrated circuit chip having a semiconductor substrate in which integrated circuitry is fabricated as is known in the art. In some implementations, data processing system 100 may comprise a processor complex forming a portion of a larger scale data processing system.

In the depicted embodiment, data processing system 100 is a symmetric multiprocessor (SMP) system including a system fabric 102, which may include, for example, one or more bused or switched communication links. In one exemplary embodiment, system fabric 102 may be implemented utilizing a ring interconnect. Coupled to system fabric 102 is a plurality of data processing system components capable of communicating various requests, addresses, data, coherency, and control information via system fabric 102. These components include a plurality of caches 106, each providing one or more levels of relatively low latency temporary storage for data and instructions likely to be accessed by an associated processor core 104. As is known in the art, each processor core 104 processes data through the execution and/or processing of program code, which may include, for example, software and/or firmware and associated data, if any. This program code may include, for example, a hypervisor, one or more operating system instances to which the hypervisor may allocate logical partitions (LPARs), and/or application programs.

Data processing system 100 additionally includes a memory controller 108 that controls read and write access to off-chip system memory. In the depicted embodiment, memory controller 108 includes a RAIM unit 110 supporting attachment of a RAIM system 112. RAIM unit 110 includes a RAIM fetch circuit 114 configured to fetch data from RAIM system 112 and a RAIM store circuit 116 configured to store data to RAIM system 112.

RAIM system 112 includes multiple parallel memory channels, each including a channel bus 118 and at least one memory module 120. Each memory module 120, in turn, includes one or more (and typically multiple) memory chips 122. In at least some embodiments, memory chips 122 can be implemented with a volatile memory technology, such as dynamic random access memory (DRAM) or static random access memory (SRAM). As is known in the art, data blocks stored within RAIM system 112 are distributed across multiple channels to promote data integrity with low latency and high availability. In one exemplary embodiment, each data block is 80 symbols in length, including sixty-four 8-bit data symbols and sixteen 8-bit Reed-Solomon ECC symbols. Assuming RAIM system 112 includes eight memory channels each including one memory module 120 containing ten memory chips 122, RAIM store circuit 116 can store a data block to RAIM system 112 by mapping each of the 80 symbols of the data block to a respective one of memory chips 122 in RAIM system 112. In this example, RAIM fetch circuit 114 can be configured to perform the following data corrections simultaneously for a given data block read (fetched) from RAIM system 112: (1) data correction for a new single DRAM error (i.e., error(s) in a single symbol), (2) data correction for a previously marked channel (i.e., error(s) in up to 10 symbols), and (3) data correction for a previously marked DRAM chip (i.e., error(s) in up to 3 symbols).

Data processing system 100 further includes an input/output (I/O) gateway 130 supporting input/output communication with various input/output adapters (IOAs) 134, such as, for example, network adapters, storage device controllers, display adapters, peripheral adapters, etc. In some embodiments, I/O gateway 130 may be communicatively coupled with one or more of IOAs 134 via an I/O fabric 132, such as a peripheral component interconnect express (PCIe) bus. In some embodiments, data processing system 100 may also include a bus interface 136 that supports the connection of data processing system 100 with one or more additional homogeneous or heterogeneous processor complexes (or other processing nodes) to form a larger scale data processing system.

Those of ordinary skill in the art will appreciate that the architecture and components of a data processing system can vary between embodiments. For example, other components, storage devices, and/or interconnects may alternatively or additionally be used. Accordingly, the exemplary data processing system 100 given in FIG. 1 is not meant to imply architectural limitations with respect to the claimed inventions.

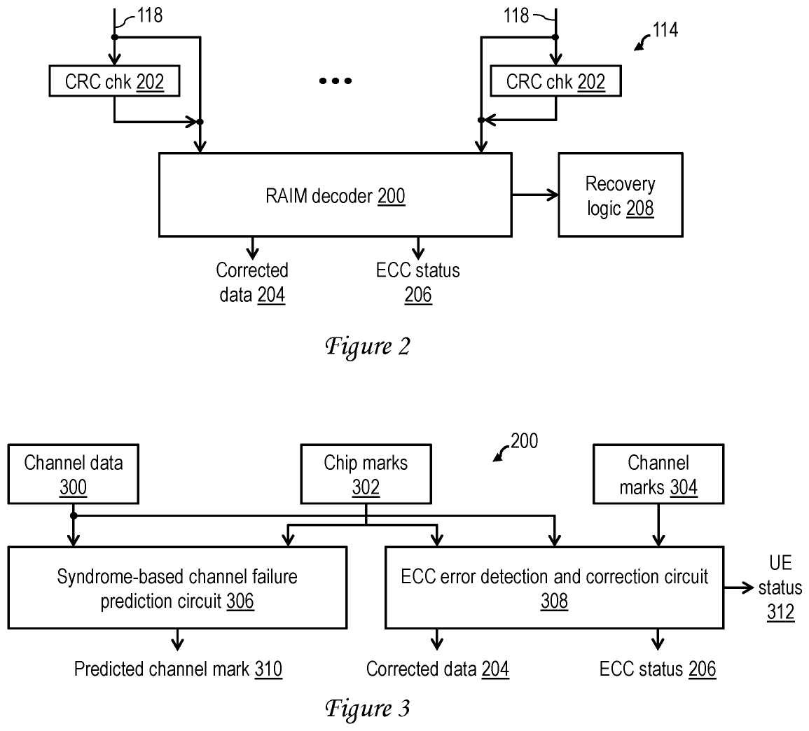

Referring now to FIG. 2, there is depicted a more detailed block diagram of RAIM fetch circuit 114 of memory controller 108 of FIG. 1 in accordance with one embodiment. In this embodiment, RAIM fetch circuit 114 includes a RAIM decoder 200 communicatively coupled to each of channel buses 118 of RAIM system 118. RAIM decoder 200 decodes and corrects (if necessary) data blocks read from RAIM system 112 and received by RAIM decoder 200 via channel buses 118.

In this example, RAIM system 112 protects the integrity of data transmitted by memory module 120 via channel buses 118 utilizing a cyclic redundancy code (CRC). RAIM fetch circuit 114 accordingly includes per-channel CRC checkers 202, which calculate a CRC over channel data and output to RAIM decoder 200 a channel marking for any failing channel detected based on a CRC mismatch. To reduce read access latency, it is preferred in at least some embodiments for channel data (containing data symbols and/or ECC symbols) to be forwarded to RAIM decoder 200 for processing prior to CRC checkers 202 completing the computation of the CRC utilized to detect channel-induced errors. As explained below with respect to FIG. 3, errors in the channel data induced by channel failure can be predicted and corrected by RAIM decoder 200.

If RAIM decoder 200 detects either no error in a data block or only correctable errors (CEs), RAIM decoder 200 outputs corrected data 204 and an ECC status 206 indicating the ECC error(s), if any, corrected in corrected data 204. The corrected data 204 can then be appropriately handled by memory controller 108, for example, by transmitting the corrected data 204 to a requestor via system fabric 102. If, on the other hand, RAIM decoder 200 detects at least one uncorrectable error (UE) in the data block read from RAIM system 112, RAIM decoder 200 invokes error recovery processing by recovery logic 208 in order to recover the data block containing the UE. As noted below, in at least some cases, recovery of the data block can include re-reading the data block containing the UE from RAIM system 112 or from data buffers within fetch circuit 114.

With reference now to FIG. 3, there is illustrated a more detailed block diagram of RAIM decoder 200 of FIG. 2 in accordance with one embodiment. In this example, RAIM decoder 200 includes syndrome-based channel failure prediction circuit 306 and ECC error detection and correction circuit 308. As indicated, circuits 306 and 308 are configured to operate in parallel on the inputs of RAIM decoder 200, namely, the channel data 300 received via channel buses 118, chip marks 302 temporarily designating chips 122 storing symbols in which ECC errors have recently been detected, and channel marks 304 temporarily designating channels in which CRC errors have recently been detected and/or predicted. RAIM fetch circuit 114 can generate chip marks 302 based at least in part based on the ECC status 206 generated for one or more prior fetch operations. In one exemplary embodiment, an unillustrated scrub engine within memory controller 108 performs background fetch operations to “scrub” RAIM system 112 for errors. The scrub engine can count correctable errors in the data retrieved by the background fetch operations from each chip 122 and determine when a chip mark should be placed. These chip marks can be maintained in a separate array within memory controller 108 for use by future fetch operations accessing the same set of chips 122. RAIM decoder 200 can generate channel marks 304 based on predicted channel marks generated by syndrome-based channel failure prediction circuit 306. Additionally, fetch circuit 114 can generate channel marks based on CRC errors detected by CRC checkers 202.

Syndrome-based channel failure prediction circuit 306 receives channel data 300 and chip marks 302 for a given data block fetch. Based on these inputs, syndrome-based channel failure prediction circuit 306 generates a selected number of channel-induced syndromes. Based on these channel-induced syndromes, syndrome-based channel failure prediction circuit 306 determines whether or not the syndromes are indicative of the temporary failure of a unique channel bus 118. If so, syndrome-based channel failure prediction circuit 306 generates a predicted channel mark 310, reflecting an expected (but not yet determined) result of the CRC checking performed by a CRC checkers 202. The predicted channel mark 310 indicates that symbols received from the marked memory channel should be disregarded when decoding an ECC-encoded data block. Those skilled in the art can appreciate that in some embodiments RAIM decoder 200 can include additional unillustrated circuitry that compares predicted channel marks 310 generated by syndrome-based channel failure prediction circuit 306 and the ECC status 206 generated by ECC error detection and correction circuit 308 to ensure integrity of the error correction of RAIM decoder 200 using cross-checks.

ECC error detection and correction circuit 308 receives channel data 300, chip marks 302, and channel marks 304 applicable to a given fetched data block. In general, ECC error detection and correction circuit 308 disregards (ignores) data symbols and ECC symbols identified by the chip marks 302, if any, and channel marks 304, if any, and generates, if possible, corrected data 204 from the remaining data symbols and ECC symbols utilizing possibly conventional ECC decoding techniques. In this case, ECC error detection and correction circuit 308 additionally outputs an ECC status 206 identifying the corrected data symbols, if any. If, however, ECC error detection and correction circuit 308 is unable to correct all error-containing data symbols in the data block, ECC error detection and correction circuit 308 asserts a UE status 312 that initiates recovery of the data block by recovery logic 208. In accordance with a preferred embodiment, the channel marks 304 utilized by ECC error detection and correction circuit 308 to identify symbols to be disregarded during ECC decoding include predicted channel marks 310 generated by syndrome-based channel failure prediction circuit 306 when processing channel data 300 and chip marks 302 associated with a prior fetch of a data block.

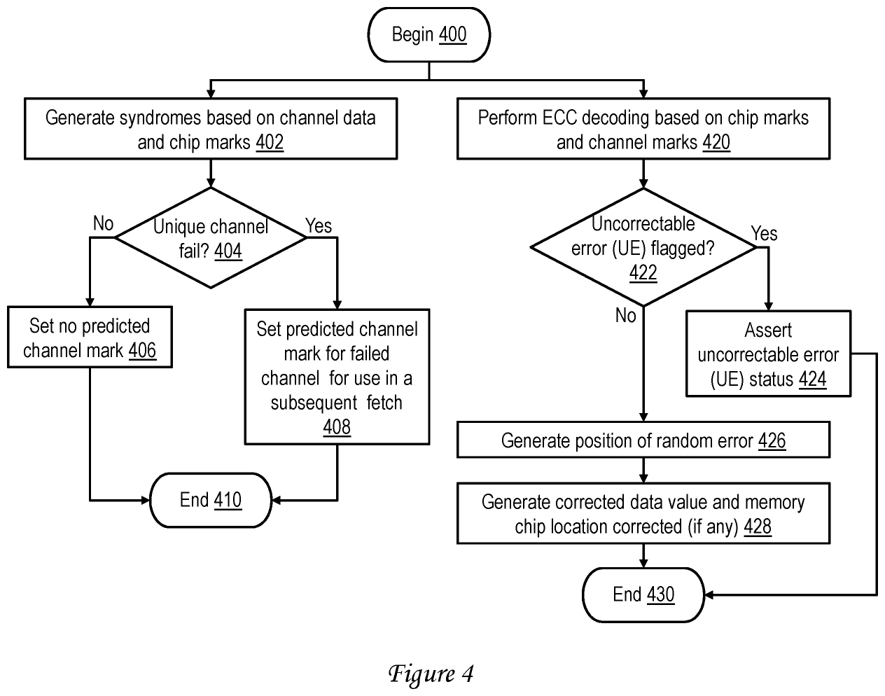

Referring now to FIG. 4, there is depicted a high-level logical flowchart of an exemplary method of RAIM decoding in accordance with one embodiment. The illustrated process may be performed, for example, in hardware and/or software/firmware by RAIM decoder 200 in various embodiments.

The process of FIG. 4 begins at block 400, for example, in response to RAIM decoder 200 receiving a data block from RAIM system 112 via channel buses 118. The process then proceeds in parallel from block 400 to each of blocks 402 and 420. Block 402 and following blocks represent the processing performed by syndrome-based channel failure prediction circuit 306; block 420 and following blocks represent the processing performed by ECC error detection and correction circuit 308.

Referring first to block 402, syndrome-based channel failure prediction circuit 306 generates a selected number of syndromes based on the channel data and the chip mark(s) 302, if any, associated with the channel data. As noted above, the chip marks 302 indicate which data symbol(s) and/or ECC symbol(s) should be disregarded in a given data block based on chip failures noted during the current and/or prior fetch operations. Based on testing the syndromes generated at block 402, syndrome-based channel failure prediction circuit 306 determines at block 404 whether or not a new unique channel failure is predicted for any of the memory channels of RAIM system 112. In response to a negative determination at block 404, syndrome-based channel failure prediction circuit 306 outputs a predicted channel mark 310 indicating that no new unique channel failure is predicted, as shown at block 406. If, however, syndrome-based channel failure prediction circuit 306 determines at block 404 that a new unique channel failure is predicted utilizing the syndromes generated at block 402, syndrome-based channel failure prediction circuit 306 sets a predicted channel mark 310 identifying the unique new channel on which a channel failure is predicted (block 408). As indicated in block 408, the predicted channel mark 306 can be utilized to exclude symbols from use by ECC error detection and correction circuit 308 in decoding channel data returned by a subsequent fetch operation, such as a subsequent fetch operation requesting the same data block. Following either block 406 or block 408, the processing performed by syndrome-based channel failure prediction circuit 306 for the given fetch operation ends at block 410.

Concurrently with the processing performed by syndrome-based channel failure prediction circuit 306 depicted at blocks 402 to 410, ECC error detection and correction circuit 308 performs the processing illustrated at blocks 420 to 430. At block 420, ECC error detection and correction circuit 308 performs ECC decoding based on the chip marks 302, if any, and channel marks 304, if any, applicable to the fetched data block. That is, ECC error detection and correction circuit 302 performs ECC decoding, if possible, without use of the data or ECC symbol(s), if any, identified by chip marks 302 and without use of the data or ECC symbol(s), if any, identified by channel marks 304. It should be particularly noted that, unlike some prior art systems, the decoding performed at block 420 is not dependent upon or delayed by the generation of a predicted channel mark 310. Thus, RAIM decoder 200 refrains from using a predicted channel mark 310 generated from a given fetch operation by syndrome-based channel failure prediction circuit 306 in the decoding of the channel data of that same fetch operation.

At block 422, ECC error detection and correction circuit 302 determines whether or not an uncorrected error (UE) is detected by the decoding performed at block 420. If so, ECC error detection and correction circuit 308 asserts UE status 312 to initiate recovery processing by recovery logic 208 (block 424). For at least some UE cases, this recovery processing includes replaying a fetch operation for the same data block and utilizing the predicted channel mark 310 generated by syndrome-based channel failure prediction circuit 306 to exclude symbols fetched from the failing channel from the decoding performed by ECC error detection and correction circuit 308. In some embodiments, replaying the fetch operation entails re-fetching the data block from RAIM system 112; in other embodiments, replaying the fetch operation entails re-reading the data block from data buffers within fetch circuit 114 rather than from RAIM system 112. It is often the case that an error initially flagged as a UE on a first pass through RAIM decoder 200 becomes correctable on a second pass through RAIM decoder 200 (i.e., when the fetch operation is replayed). If ECC error detection and correction circuit 302 determines at block 422 that no UE was detected, ECC error detection and correction circuit 302 generates an indication of the position of a new random error (block 426). In addition, ECC error detection and correction circuit 302 generates the corrected data value for the new random error and identifies the memory chip 122 associated with the new random data error (block 428). Thereafter, the processing performed by ECC error detection and correction circuit 302 ends at block 430.

It should be appreciated that, in some embodiments, channel marks can be generated through different means other than the predicted channel marks 310 previously described. For example, in a memory system in which memory refresh is staggered across N memory channels, a RAIM unit 110 can dynamically generate a channel mark to exclude channel data of a channel undergoing a refresh cycle. Dynamically generating channel marks based on the memory refresh schedule results in improved fetch performance because RAIM decoder 200 can proceed with processing channel data from N−1 channels (with the dynamic channel mark excluding channel data from the remaining channel) without waiting for the last channel undergoing refresh to deliver its channel data. RAIM unit 110 can also generate and apply a channel mark permanently to a memory channel that is no longer functioning properly due to a catastrophic failure on channel bus 118 or memory module 120. Both dynamic and permanent channel marks can potentially be generated based on a channel's transient error condition (e.g., CRC error), which may or may not be known at the time that channel data is received by RAIM decoder 200. In this case, RAIM decoder 200 cannot provide a predicted channel mark because a channel mark is already present as an input to RAIM decoder 200. Recovery logic 208 can then initiate a recovery action to refetch data from all memory channels and wait for any CRC errors to be resolved before forwarding channel data for a second pass through RAIM decoder 200. Memory refetch and fetch replay sequences can be combined in multiple passes through the RAIM decoder 200 to provide robust correction for a variety of errors while optimizing latency through the decoder for the common scenario in which no new channel error is present. In at least some embodiments, recovery logic 208 can be configured to prevent repeating memory refetches and report a final UE to the requestor in the rare event that these sequences do not resolve an initial UE reported by the RAIM decoder 200. In some embodiments, a memory controller 108 can handle various exemplary fetch scenarios as summarized in Table I below

TABLE I

| RAIM decoder | RAIM decoder | RAIM decoder | RAIM decoder | |
|---|---|---|---|---|
| input (1^{st} pass) | output (1^{st} pass) | input (2^{nd} pass) | output (2^{nd} pass) | Action |
| Channel data | No error | n/a | n/a | Forward data to requestor. |
| with no | | | | |
| channel mark | | | | |
| Channel data | Correctable error | n/a | n/a | Forward data to requestor, |
| with no | | | | indicate failing new chip if |
| channel mark | | | | new random error, and/or |
| | | | | any chip(s) corrected due |
| | | | | to chip mark(s). |
| Channel data | Uncorrectable error | Channel data | CE, UE | Replay fetch (using data |
| with no | (UE) with predicted | with channel | | from data buffers in RAIM |
| channel mark | channel mark | mark (predicted | | fetch circuit) and provide |
| | | from 1^{st} pass) | | predicted channel mark as |
| | | | | new input to RAIM |
| | | | | decoder on 2^{nd} pass; |
| | | | | If UE is not present on 2^{nd} |
| | | | | pass forward data to |
| | | | | requestor along with |
| | | | | indication of failing new |
| | | | | chip if new random error |
| | | | | and/or any chip(s) |
| | | | | corrected due to chip |
| | | | | mark(s); |
| | | | | If UE is still present on 2^{nd} |
| | | | | pass, proceed to next row |
| | | | | unless refetch has already |
| | | | | been attempted, else report |
| | | | | final UE. |
| Channel data | Uncorrectable error | Channel data | No error, | Refetch channel data from |
| with no | (UE) with no | | CE, or UE | all channels of RAIM |
| channel mark | predicted channel | | | system; |
| | mark | | | If UE is not present on 2^{nd} |
| | | | | pass, forward data to |
| | | | | requestor along with |
| | | | | indication of failing new |
| | | | | chip if new random error |
| | | | | and/or any chip(s) |
| | | | | corrected due to chip |
| | | | | mark(s); |
| | | | | If UE is present on 2^{nd} pass |
| | | | | with a predicted channel |
| | | | | mark, then replay fetch as |
| | | | | described in previous row; |
| | | | | If UE is present on 2^{nd} pass |
| | | | | with no predicted channel |
| | | | | mark, then report final UE. |
| Channel data | No error | n/a | n/a | Forward data to requestor |
| with channel | | | | |
| mark | | | | |
| Channel data | Correctable error | n/a | n/a | Forward data to requestor, |
| with channel | (CE) | | | indicate failing new chip if |
| mark | | | | new random error, and/or |
| | | | | any chip(s) corrected due |
| | | | | to chip mark(s) |
| Channel data | Uncorrectable error | Channel data | No error, | Refetch channel data from |
| with channel | (UE) (predicted | | CE or UE | all channels of RAIM |
| mark | channel mark not | | | system; on 2^{nd} pass, do not |
| (dynamic) | possible due to input | | | re-apply dynamic channel |
| | channel mark) | | | mark; |
| | | | | If UE is not present on 2^{nd} |
| | | | | pass, forward data to |
| | | | | requestor along with |
| | | | | indication of failing new |
| | | | | chip if new random error |
| | | | | and/or any chip(s) |
| | | | | corrected due to chip |
| | | | | mark(s); |
| | | | | If UE is present on 2^{nd} pass |
| | | | | with predicted channel |
| | | | | mark, then replay fetch as |
| | | | | described in row 3. |
| | | | | If UE is reported on 2^{nd} |
| | | | | pass with no predicted |
| | | | | channel mark, report final |
| | | | | UE. |
| Channel data | Uncorrectable error | Channel data | No error, | Refetch channel data from |
| with channel | (UE) (predicted | with channel | CE or UE | all channels of RAIM |
| mark | channel mark not | mark (static, | | system; on 2^{nd} pass, re- |
| (permanent) | possible due to input | permanent) | | apply permanent channel |
| | channel mark) | | | mark; |
| | | | | If UE is not present on 2^{nd} |
| | | | | pass, then forward data to |
| | | | | requestor along with |
| | | | | indication of failing new |
| | | | | chip if new random error |
| | | | | and/or any chip(s) |
| | | | | corrected due to chip |
| | | | | mark(s); |
| | | | | If UE is still present, report |
| | | | | final UE. |

As has been described, in at least one embodiment, a memory controller stores each of a plurality of data blocks encoded by error correction code (ECC) across multiple channels of a redundant memory system. Based on receiving, from the memory system, channel data of a fetch operation requesting a data block, the memory controller decodes the channel data and concurrently generates a predicted channel mark based on tests of channel-induced syndromes generated from the channel data. The predicted channel mark identifies a marked channel among the multiple channels as a likely source of data errors. The memory controller determines whether the decoding detects an uncorrectable error in the channel data and, based on determining the decoding detects an uncorrectable error in the channel data re-reads channel data corresponding to the data block and corrects the channel data by excluding, from decoding, channel data received from the marked channel. In some embodiments, the channel data may be re-fetched from the memory system. In other embodiments, the memory controller may contain data buffers for buffering data received from the memory system, and the channel data can be re-read from these data buffers rather than from the memory system.

By decoding the data block in parallel with the generation of the predicted channel mark, the critical path through the RAIM decoder is reduced, improving fetch latency for the most common case in which no channel mark is predicted.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been particularly shown as described with reference to one or more preferred embodiments, it will be understood by those skilled in the art that various changes in form and detail may be made therein without departing from the spirit and scope of the appended claims. As employed herein, a “storage device” is specifically defined to include only statutory articles of manufacture and to exclude signal media per se, transitory propagating signals per se, and energy per se.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A method of data processing in a data processing system, the method comprising:
a memory controller storing each of a plurality of data blocks across multiple channels of a memory system, wherein each of the plurality of data blocks is encoded with an error correction code (ECC);
based on receiving, from the memory system, channel data of a fetch operation requesting a data block among the plurality of data blocks, the memory controller decoding the channel data and concurrently generating a predicted channel mark based on tests of channel-induced syndromes generated from the channel data, wherein the predicted channel mark identifies a marked channel among the multiple channels as a likely source of data errors;
the memory controller determining whether the decoding detects an uncorrectable error in the channel data; and
based on determining the decoding detects an uncorrectable error in the channel data, the memory controller re-reading channel data corresponding to the data block and correcting the re-read channel data by excluding, from decoding, channel data received from the marked channel.

2. The method of claim 1, wherein:
each of the multiple channels includes multiple memory chips; and
the method includes the memory controller, based on the decoding detecting an error in channel data received from one of the multiple memory chips, generating a chip mark identifying said one of the multiple memory chips from which channel data is to be disregarded in a subsequent fetch operation.

3. The method of claim 1, further comprising:
the memory controller refraining from utilizing the predicted channel mark in the decoding of the channel data.

4. The method of claim 1, further comprising:
the memory controller performing cyclic redundancy code (CRC) checking for each of the multiple channels; and
based on the CRC checking, the memory controller generating channel marks.

5. The method of claim 1, wherein:
the data block includes a plurality of symbols; and
the storing includes the memory controller storing at least one of the plurality of symbols to each of the multiple channels.

6. The method of claim 5, wherein:
each of the multiple channels includes multiple memory chips; and
the storing includes the memory controller storing each of the plurality of symbols in a different respective one of the memory chips.

7. A data processing system, comprising:
a memory controller including:
a store circuit configured to store each of a plurality of data blocks across multiple channels of a memory system, wherein each of the plurality of data blocks is encoded with an error correction code (ECC);
a fetch circuit configured to perform:
based on receiving, from the memory system, channel data of a fetch operation requesting a data block among the plurality of data blocks, decoding the channel data and concurrently generating a predicted channel mark based on tests of channel-induced syndromes generated from the channel data, wherein the predicted channel mark identifies a marked channel among the multiple channels as a likely source of data errors;
determining whether the decoding detects an uncorrectable error in the channel data; and
based on determining the decoding detects an uncorrectable error in the channel data, re-reading channel data corresponding to the data block and correcting the re-read channel data by excluding, from decoding, channel data received from the marked channel.

8. The data processing system of claim 7, wherein:
each of the multiple channels includes multiple memory chips; and
the fetch circuit is configured to perform:
based on the decoding detecting an error in channel data received from one of the multiple memory chips, generating a chip mark identifying said one of the multiple memory chips from which channel data is to be disregarded in a subsequent fetch operation.

9. The data processing system of claim 7, wherein the fetch circuit refrains from utilizing the predicted channel mark in the decoding of the channel data.

10. The data processing system of claim 7, wherein the memory controller further comprises a plurality of cyclic redundancy code (CRC) checkers, wherein the plurality of CRC checkers are configured to generate channel marks based on detection of CRC errors on the multiple channels.

11. The data processing system of claim 7, wherein:
the data block includes a plurality of symbols; and
the store circuit is configured to store at least one of the plurality of symbols to each of the multiple channels.

12. The data processing system of claim 11, wherein:
each of the multiple channels includes multiple memory chips; and
the store circuit stores each of the plurality of symbols in a different respective one of the memory chips.

13. The data processing system of claim 7, further comprising;
a system fabric coupled to the memory controller; and
a plurality of processor cores coupled to the system fabric.

14. A program product, comprising:
a storage device; and
program code stored within the storage device, wherein the program code, when executed by a memory controller of a memory system including multiple channels, causes the memory controller to perform:
storing each of a plurality of data blocks across the multiple channels of the memory system, wherein each of the plurality of data blocks is encoded with an error correction code (ECC);
based on receiving, from the memory system, channel data of a fetch operation requesting a data block among the plurality of data blocks, decoding the channel data and concurrently generating a predicted channel mark based on tests of channel-induced syndromes generated from the channel data, wherein the predicted channel mark identifies a marked channel among the multiple channels as a likely source of data errors;
determining whether the decoding detects an uncorrectable error in the channel data; and
based on determining the decoding detects an uncorrectable error in the channel data, re-reading channel data corresponding to the data block and correcting the re-read channel data by excluding, from decoding, channel data received from the marked channel.

15. The program product of claim 14, wherein:
each of the multiple channels includes multiple memory chips; and
the program code further causes the memory controller to perform:
based on the decoding detecting an error in channel data received from one of the multiple memory chips, generating a chip mark identifying said one of the multiple memory chips from which channel data is to be disregarded in a subsequent fetch operation.

16. The program product of claim 14, wherein the program code further causes the memory controller to perform:
refraining from utilizing the predicted channel mark in the decoding of the channel data.

17. The program product of claim 14, wherein the program code further causes the memory controller to perform:
performing cyclic redundancy code (CRC) checking for each of the multiple channels; and
based on the CRC checking, generating channel marks.

18. The program product of claim 14, wherein:
the data block includes a plurality of symbols; and
storing the plurality of data blocks includes the memory controller storing at least one of the plurality of symbols to each of the multiple channels.

19. The program product of claim 18, wherein:
each of the multiple channels includes multiple memory chips; and
storing the plurality of data blocks includes the memory controller storing each of the plurality of symbols in a different respective one of the memory chips.
